(19) United States
(12) Patent Application Publication
(10) Pub. No.: US 2018/0162607 A1
(43) Pub. Date: Jun. 14, 2018

(54) Food Keeper-and-Dispenser

(71) Applicant: Roderic A. Rivera, Glen Ellyn, IL (US)

(72) Inventor: Roderic A. Rivera, Glen Ellyn, IL (US)

(21) Appl. No.: 15/836,906

(22) Filed: Dec. 10, 2017

Related U.S. Application Data
(60) Provisional application No. 62/497,965, filed on Dec. 10, 2016.

(51) Int. Cl. B65D 47/08; B65D 1/02; B65D 47/32; B65D 83/00; B65D 47/20; B65D 81/34; A47J 9/00

(52) U.S. Cl. CPC B65D 47/0804; B65D 1/0223; B65D 1/0207; A47J 9/00; B65D 83/0022; B65D 47/2031; B65D 81/3446; B65D 47/32

(57) ABSTRACT

A food keeper-and-dispenser has a body unit, a collar and a cap. In some embodiments, the body unit has a closed end and an open end. The closed end can include a one-way valve. The cap can have a base, a hinge and a lid. In some embodiments, the cap can also have a nozzle to dispense the contained substance.

### CROSS-REFERENCE TO RELATED APPLICATIONS

This application is a non-provisional application which is related to and claims priority from U.S. Provisional Application No. 62/497,965 filed Dec. 10, 2016 entitled “Butter Keeper, Warmer & Dispenser”. The '965 application is hereby incorporated in its entirety.

### FIELD OF THE INVENTION

The present invention relates to storage, warming, and dispensing of substances such as foods like butter and frosting. More specifically, the invention relates to a holder that can be used to store, soften and dispense food from a single container.

Many types of food items such as butter, lard, frosting, and the like can benefit from softening before they are incorporated into dishes for cooking and baking. Often these items are removed from store-bought containers, put into dishes and heated in a microwave and/or left at room temperature to soften/melt. This process of softening/melting lengthens the preparation time of meals, increases the chance for food contamination for food left at room temperature for extended periods of time, tends to create waste (as more material is often softened than needed), and creates additional dishes to be cleaned.

For example, butter, which is frequently used as a topping for foods like baked potatoes, toast, pancakes, and popcorn is typically stored in the refrigerator and then must sit for an extended period at room temperature and/or be heated before it can be easily spread. Similarly, food items used in decorative baking such as frosting are typically mixed and stored in the refrigerator until use. Like butter, frosting often needs to soften before it can be spread or scooped into a pastry bag and piped onto baked goods like cakes, cupcakes and pastries. When baking, often excess frosting is made and must be thrown out as it is inconvenient to store it until it is needed again

What is needed is a device that allows a user to store, soften and dispense foods such as butter, lard and frosting from a single container and, at least in some embodiments, store these foods for future use.

### SUMMARY OF THE INVENTION

In some embodiments, a food keeper-and-dispenser can include a body unit, a cap and a collar. In some embodiments, the body unit can include a closed end and an open end. In some embodiments, the closed end contains a one-way valve. In some embodiments, the one-way valve is a duckbill-valve. In some embodiments, the open end contains a lip and/or a set of threads. In some embodiment, the interior side of the collar is threaded.

In some embodiments, the cap contains, a base, a nozzle, a hinge and/or a lid. In some embodiments, the base is threaded. In some embodiments, the lid had a flat side. In some embodiments, the shape of the nozzle is square, rectangular, star-shaped, circular, triangular, or oval. In some embodiments, the nozzle is a one-way valve. In some embodiments, the nozzle is a duckbill valve.

In some embodiments, the body unit is rectangular in shape. In some embodiments, the body unit is composed of a flexible elastomer such as silicone or rubber configured to be squeezed. In some embodiments, the elastomer is food-grade. In some embodiments, the interior of said body unit comprises a nonstick coating. In some embodiments, the food keeper-and-dispenser is made of microwavable material(s).

In some embodiments, the body unit is made of metal material(s). In some embodiments, the body unit is configured to receive a plunger via the closed end.

In some embodiments, the body unit, collar, and/or cap contain magnetic sections configured to aid in joining the body unit, collar and/or cap.

In some embodiments, the food keeper-and-dispenser includes a temperature sensor. In some embodiments, the body unit contains a thermochromic material.

A food keeper-and-dispenser can include a body unit, a collar, a cap and/or an attachment. In some embodiments, the cap can have an attached nozzle to dispense the contained substance and/or a lid to seal the food keeper-and-dispenser and allow for upright storage.

In some embodiments, the body unit of the food keeper-and-dispenser can be heated, among other ways, by hand, with warm water, on a heat plate, and/or with a microwave to warm the contained substance. In some such embodiments, this allows for a solid or viscous substance stored in the body unit of the food keeper-and-dispenser to be heated, made flowable and dispensed from the keeper-and-dispenser in which it is stored.

The body unit of the food keeper-and-dispenser can be made of flexible material allowing for a user to squeeze and dispense the contained substance by hand.

Substances that can be contained in keeper-and-dispenser include, but are not limited to butters, frostings, chocolates, lard, shortening, jellies, syrups, dressings, and cheeses.

### BRIEF DESCRIPTION OF THE DRAWINGS

FIG. 1 is an exploded perspective view of a food keeper-and-dispenser.

FIG. 2 is a perspective view of an assembled food keeper-and-dispenser.

FIG. 3A is a side view of an embodiment of a body unit.

FIG. 3B is a cross-sectional view taken along the line A in FIG. 3.

FIG. 4A is a perspective view of an embodiment of a body unit.

FIG. 4B is a top view of an embodiment of a body unit.

FIG. 4C is a bottom view of an embodiment of a body unit.

FIG. 5A is a perspective view of an embodiment of a collar.

FIG. 5B is a side view of an embodiment of a collar.

FIG. 5C is a cross-sectional view of a collar taken along the line B in FIG. 5B.

FIG. 6A is a perspective view of an embodiment of a cap with a built-in dispenser.

FIG. 6B is a top view of one embodiment of a cap with a built-in dispenser.

FIG. 6C is a bottom view of one embodiment of a cap with a built-in dispenser.

FIG. 6D is a cross-sectional view of an embodiment of a cap with a built-in dispenser taken along line C in FIG. 6B.

### DETAILED DESCRIPTION OF ILLUSTRATIVE EMBODIMENT(S)

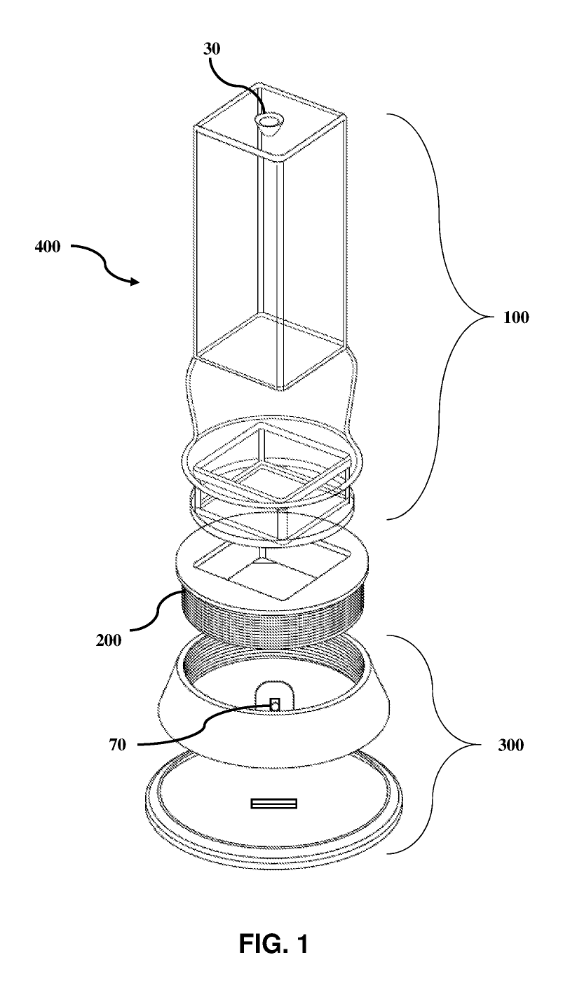

FIG. 1 illustrates an exploded perspective view of keeper-and-dispenser 400. In at least some embodiments, keep and dispenser 400 is configured to hold liquid, semi-liquid, and/or solid substance(s). In some embodiments, the substance(s) is/are food, such as, but not limited to, butters, lard, frostings, cheeses, chocolates, shortening, jellies, syrups, and dressings.

Components of keeper-and-dispenser 400 can include, but are not limited to, body unit 100, collar 200 and cap 300. In at least some embodiments, when assembled, keeper-and-dispenser 400 allow for a contained substance, such as butter, to be sealed and stored upright in a desired environment such as a refrigerator.

In some embodiments, body unit 100 is interchangeable with various caps with various sized and/or shaped nozzles 70. In some embodiments, the shape of nozzle 70 is one of a square, rectangle, star, circle, triangle, or oval.

Substances that can be contained in keeper-and-dispenser 400 include but are not limited to butters, lard, frostings, cheeses, chocolates, shortening, jellies, syrups, and dressings. In some embodiments, a user can switch an individual cap 300 between various body units 100 containing various types of food.

Body unit 100 can be made of a flexible elastomer such as, but not limited to, silicone or rubber. In some embodiments, the elastomer is food-grade. In some embodiments, a user can apply a coating to the interior of body unit 100 to create a smooth non-stick surface. In some embodiments, the interior of body unit 100 is made of a non-stick material such as, but not limited to, polytetrafluoroethylene. In some embodiments, the elastomer used in body unit 100 can be modified to increase its thermal conductivity.

In some embodiments, where squeezing is not required, body unit can be made from more ridged materials such as, but not limited to, various types of glasses or metals. In some unillustrated embodiments, particularly those utilizing a ridged body unit, the side of body unit 100 opposite of cap 200 can be configured to receive a plunger/ram configured to aid in pushing the food material through nozzle 70.

In some embodiments, body unit 100 can be heated by means of body temperature (for example holding or rolling between one's hands), submerging in or running under warm/hot water, placing it on a hot plate, an electronic heat source connected to keeper-and-dispenser 400 and/or microwaving body unit 100. In some embodiments, keeper-and-dispenser 400 is made of microwavable material(s). In some embodiments, the flexible nature of body unit 100 allows a user to squeeze and dispense the contained substance out of nozzle 70 by hand.

In some embodiments, body unit 100 is sized to hold a standard stick of butter.

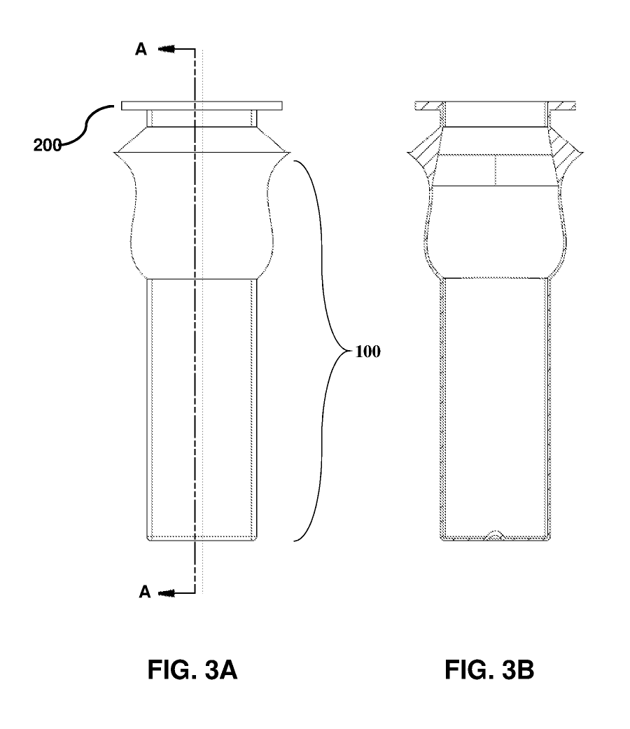

In at least some embodiments, body unit 100 can be manufactured by various methods including, but not limited to, injection molding and additive manufacturing. Body unit 100 can be manufactured in various shapes and sizes. In some embodiments the size and/or shape of body unit 100 and/or nozzle 70 are configured to accommodate a particular food. One embodiment is illustrated in FIG. 3A and FIG. 3B.

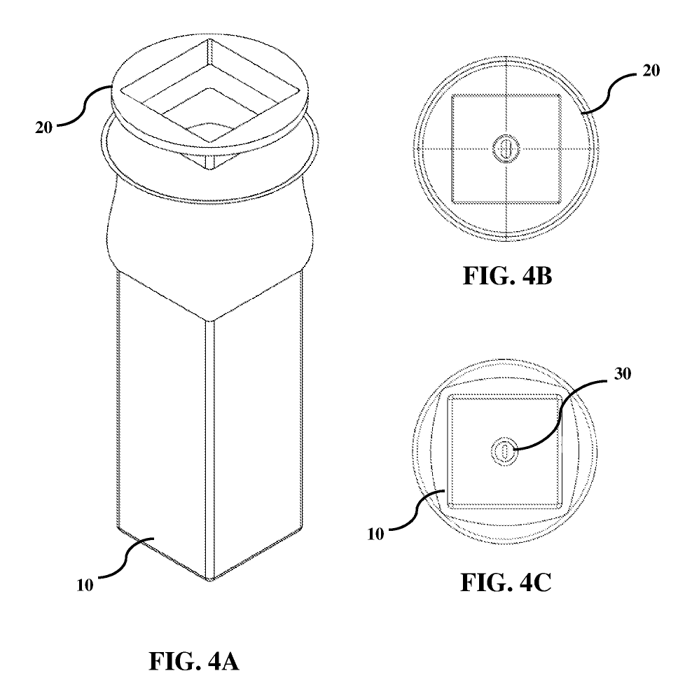

In some embodiments, body unit 100 can be molded to have a closed end 10 as illustrated in FIG. 4A. In some embodiments, closed end 10 can be molded to include a one-way valve 30 made of a flexible material including, but not limited to, silicone. In some embodiments, one-way valve 30 can be a duckbill check valve.

In at least some embodiments, particularly those where body unit 100 is meant to be compressed by hand, one-way valve 30 allows air to enter body unit 100 from closed end 10 when a user stops squeezing body unit 100. This allows the contained substance, such as butter, to remain at open end 20, while still allowing body unit 100 to return to its pre-squeezed shape. This is particularly useful when nozzle 70 is also a one-way valve which would not allow air to reenter body unit 100. Allowing body unit 100 to return to a pre-squeezed shape can aid in the storage of keeper-and-dispenser 400.

In some embodiments, body unit 100 can be molded to remain open on one or both top and/or bottom end(s). In at least certain embodiments, open end(s) 20 of body unit 100 can be molded with either threads or a lip capable of connecting to attachments or caps. In some embodiments, attachments and caps can be made of durable material such as polycarbonate.

In some embodiments with two open ends, a cap for one of the two open ends can contain a one-way valve made of a flexible material including but not limited to silicone. In some embodiments, the one-way valve can be a duckbill check valve.

In some embodiments, open end 20 of body unit 100 serves to dispense, close and seal body unit 100 for upright storage using attachments and/or caps. In some embodiments, open end 20 can be molded with either threads or a lip to connect to collar 200.

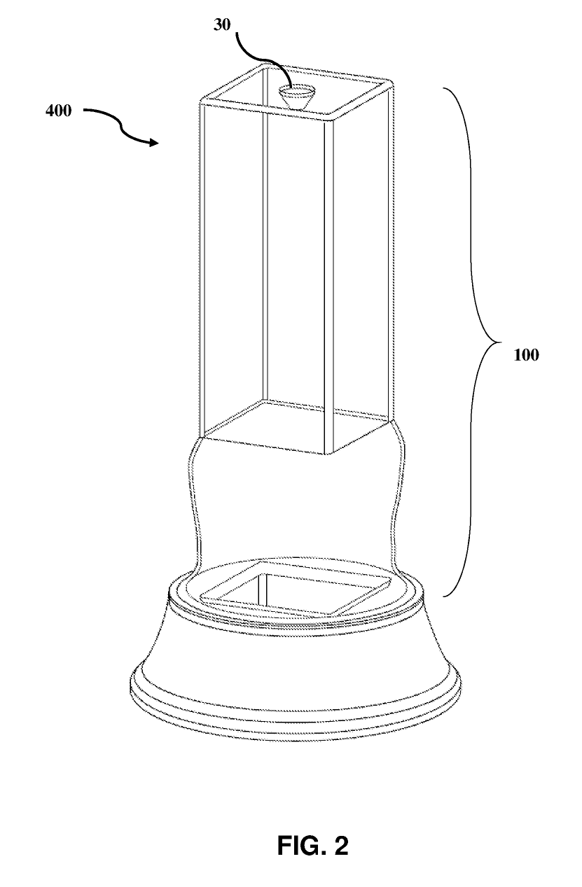

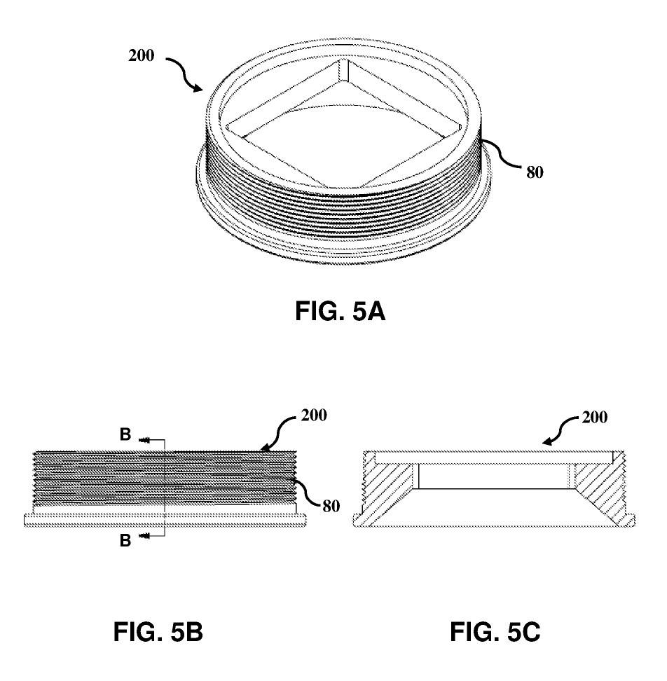

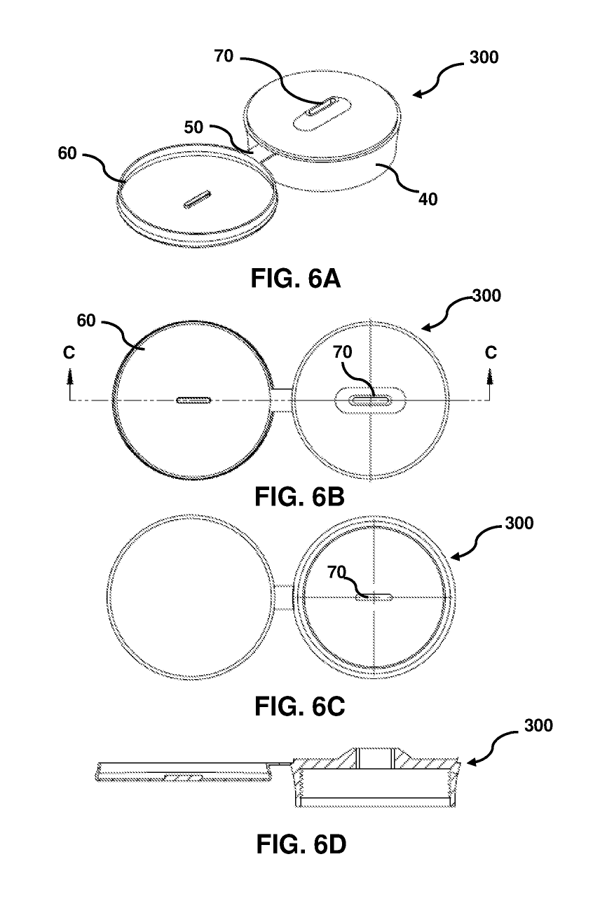

Turning to FIG. 5, collar 200 can have threads 80 to attach to cap 300 and/or to unit body 100. In some embodiments, cap 300 can contain base 40 to screw on to collar 200, hinge 50 and flat lid 60 capable of snapping onto the base allowing for the unit to be sealed and stored upright on the flat lid 60 as depicted in FIG. 2.

In some embodiments, body unit 100, cap 300, and/or collar 200 can be made of magnetic material or contain magnetic areas configured to aid in connecting cap 300, collar 200, and/or body unit 100.

In at least some embodiments, cap 300 has a nozzle 70 to dispense the contained substance. In some embodiments, nozzle 70 can be tapered at the end with a hole and/or slit to dispense the contained substance. In some embodiments, nozzle 70 can have removable tips that when attached dispense the contained substance in different shapes such as a star, ribbon or flower. In at least some embodiments, hinge 50 serves to connect base 40 and flat lid 60 to render cap 300 one, continuous piece.

In some embodiments, such as those shown in FIG. 1, body unit 100 can be utilized to store a common, store-bought stick of butter. The stick of butter can be inserted into open end 20 of body unit 100 to rest on closed end 10. Collar 200 can attach to open end 20 of body unit 100. Cap 300 can then be threaded on to collar 200. Flat lid 60 can be used to seal assembled keeper-and-dispenser 400. Keeper-and-dispenser 400 can then be inverted to rest on flat lid 60 and placed in the refrigerator.

When a user wishes to dispense butter, keeper-and-dispenser 400 can be removed from the refrigerator and warmed by various means, such as those discussed above. The user can then remove lid 60 of cap 300 to dispense the warmed butter through nozzle 70.

In some embodiments, keep and dispenser 400 can include at temperature sensor to indicate the temperate of the substance stored in body unit 100. In some embodiments, the temperature sensor is digital. In some embodiments, body unit 100 can be made of a thermochromic that changes color based on the temperature of the substance contained in body unit 100.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1: A food keeper-and-dispenser comprising:
a) a body unit configured to hold a stick of butter comprising:
i) a closed end wherein said closed end contains a one-way valve; and
ii) an open end, and
b) a cap comprising:
i) a base;
ii) a nozzle;
iii) a hinge; and
iv) a lid.

2: The food keeper-and-dispenser of claim 1 further comprising c) a collar.

3: The food keeper-and-dispenser of claim 2 wherein said one-way valve is a duckbill-valve.

4: The food keeper-and-dispenser of claim 2 wherein said open end contains a lip.

5: The food keeper-and-dispenser of claim 2 wherein said open end contains a set of threads.

6: The food keeper-and-dispenser of claim 2 wherein the interior side of said collar is threaded.

7: The food keeper-and-dispenser of claim 1 wherein said base is threaded.

8: The food keeper-and-dispenser of claim 1 wherein said lid has a flat side.

9: The food keeper-and-dispenser of claim 1 wherein said body unit is rectangular in shape.

10: The food keeper-and-dispenser of claim 1 wherein the shape of said nozzle is square, rectangular, star-shaped, circular, triangular, or oval.

11: The food keeper-and-dispenser of claim 1 wherein said body unit is composed of a flexible, food-grade silicone material configured to be squeezed.

12: The food keeper-and-dispenser of claim 1 wherein said body unit is composed of a flexible, food-grade rubber material configured to be squeezed.

13: The food keeper-and-dispenser of claim 1 wherein the interior of said body unit comprises a nonstick coating.

14: The food keeper-and-dispenser of claim 1 wherein said body unit is made of a metal and said body unit is configured receive a plunger via said closed end.

15: The food keeper-and-dispenser of claim 1 wherein said body unit is made of microwavable materials.

16: The food keeper-and-dispenser of claim 1 wherein said body unit and said cap contain magnetic sections configured to aid in joining said body unit to said cap.

17: The food keeper-and-dispenser of claim 1 wherein said nozzle is a duckbill-valve.

18: The food keeper-and-dispenser of claim 1 further comprising a temperature sensor.

19: The food keeper-and-dispenser of claim 1 wherein said body unit contains a thermochromic material.

20: A food keeper-and-dispenser comprising:
a) a body unit made of a of a food-grade elastomer configured to hold a stick of butter comprising:
i) a closed end;
ii) an open end; and
iii) an interior surface with a nonstick coating;
b) a cap comprising:
i) a base;
ii) a nozzle, wherein the shape of said nozzle is square, rectangular, star-shaped, circular, triangular, or oval;
iii) a hinge; and
iv) a lid with a flat side configured to allow said food keeper-and-dispenser standup right when said cap is in a closed position; and
c) a collar,
wherein said body contains a thermochromic material.
